(19) United States
(12) Patent Application Publication
(10) Pub. No.: US 2013/0010169 A1
(43) Pub. Date: Jan. 10, 2013

(54) IMAGING APPARATUS

(75) Inventors: TAKAYUKI TOCHIO, Hyogo (JP); EIJI ANNO, Nara (JP)

(73) Assignee: PANASONIC CORPORATION, Osaka (JP)

(21) Appl. No.: 13/540,649

(22) Filed: Jul. 3, 2012

(30) Foreign Application Priority Data
Jul. 5, 2011 (JP) 2011-148914

(51) Int. Cl. H04N 5/222

(52) U.S. Cl. 348/333.01; 348/E05.022

(57) ABSTRACT

An imaging apparatus includes an imaging sensor configured to capture a subject image to output image data, a display unit configured to display an image based on the output image data, a touch panel configured to receive an operation by user's touching, the touch panel arranged on the display unit, and a controller configured to control enabling/disabling of the touch operation on the touch panel based on an output from the imaging sensor.

### BACKGROUND

1. Technical Field

The present disclosure relates to an imaging apparatus having a touch panel.

2. Related Art

Recently, attention is paid to a position input device such as a touch panel that detects touches via fingers to specify a coordinate of the touched position, as an excellent user interface unit. As the position input device, several types of touch panels adopting various systems such as a resistive membrane system and a capacitive sensing method are known. In recent years, a digital camera that is equipped with a touch panel and can operate via the touch panel is widespread. A user can operate the digital camera to perform a predetermined operation by touching the touch panel.

For example, JP 11-142719 A discloses a camera apparatus that performs a focus control on an area around an object which is touched based on information of position coordinate from a pressure-sensitive sensor and records a captured image signal in a recording medium. As a result, a subject on any position on a display can be specified as an object to be focused.

A function for performing an autofocus control and a recording operation through a touch operation (operation by touching) like the camera disclosed in JP 11-142719 A is convenient. However, there is a problem in that when a user unintentionally touches the touch panel at a non-use time of the camera, an operational error occurs.

In view of the above problem, the present disclosure provides an imaging apparatus capable of reducing occurrence of user's unintended operation on a touch panel.

### SUMMARY

In a first aspect, an imaging apparatus is provided which includes an imaging sensor configured to capture a subject image to output image data, a display unit configured to display an image based on the output image data, a touch panel configured to receive an operation by user's touching, the touch panel arranged on the display unit, and a controller configured to control enabling/disabling of the touch operation on the touch panel based on an output from the imaging sensor.

In a second aspect, an imaging apparatus is provided which includes an imaging sensor configured to capture a subject image to output image data, a display unit configured to display an image based on the output image data, a touch panel configured to receive an operation by user's touching, the touch panel arranged on the display unit, a detector configured to detect shake of the imaging apparatus, and a controller configured to control enabling/disabling of the operation on the touch panel based on a detected result of the detector.

In a third aspect, an imaging apparatus is provided which includes an imaging sensor configured to capture a subject image to output image data, a display unit configured to display an image based on the output image data, a touch panel configured to receive an operation by user's touching, the touch panel arranged on the display unit, a detector configured to detect shake of the imaging apparatus, and a controller configured to control enabling/disabling of the operation on touch panel based on an output from the imaging sensor and a detected result of the detector.

According to the above aspects, an imaging apparatus can be provided in which occurrence of an operational error on the touch panel unintentionally performed by a user is reduced.

### BRIEF DESCRIPTION OF DRAWINGS

FIG. 1 is a diagram illustrating a configuration of a digital camera in a first embodiment.

FIG. 2 is a diagram showing illustrating a rear of the digital camera in the first embodiment.

FIG. 3 is a flowchart illustrating control of a touch panel according to an output of an image sensor in the first embodiment.

FIG. 4 is a diagram for explaining the control of the touch panel according to an output of the image sensor in the first embodiment.

FIG. 5 is a flowchart illustrating the control of the touch panel according to an output of a gyro sensor in a second embodiment.

FIG. 6 is a diagram for explaining the control of the touch panel according to the output of the gyro sensor in the second embodiment.

FIG. 7 is a diagram illustrating synchronization between AF control and the control of the touch panel according to the output of the gyro sensor in the second embodiment.

FIG. 8 is a flowchart illustrating the control of the touch panel according to the output of the image sensor and the output of the gyro sensor in a third embodiment.

### DETAILED DESCRIPTION OF PREFERRED EMBODIMENTS

Embodiments will be described below with reference to the accompanying drawings.

### First Embodiment

An embodiment is applied to a digital camera will be described below. The digital camera according to the first embodiment includes a CMOS image sensor, a liquid crystal display, a touch panel and a controller. The CMOS image sensor captures a subject image and outputs image data. The liquid crystal display displays an image based on the output image data. The touch panel is arranged on the liquid crystal display, and accepts a touch operation from a user. The controller controls enabling/disabling of the operation on the touch panel based on an output from the CMOS image sensor. The digital camera makes a control so that the operation of the touch panel is enabled or disabled based on an output from the CMOS image sensor. As a result, occurrence of an operational error on the touch panel unintended by the user can be reduced. A constitution and an operation of the digital camera 100 will be described below.

### 1-1. Configuration

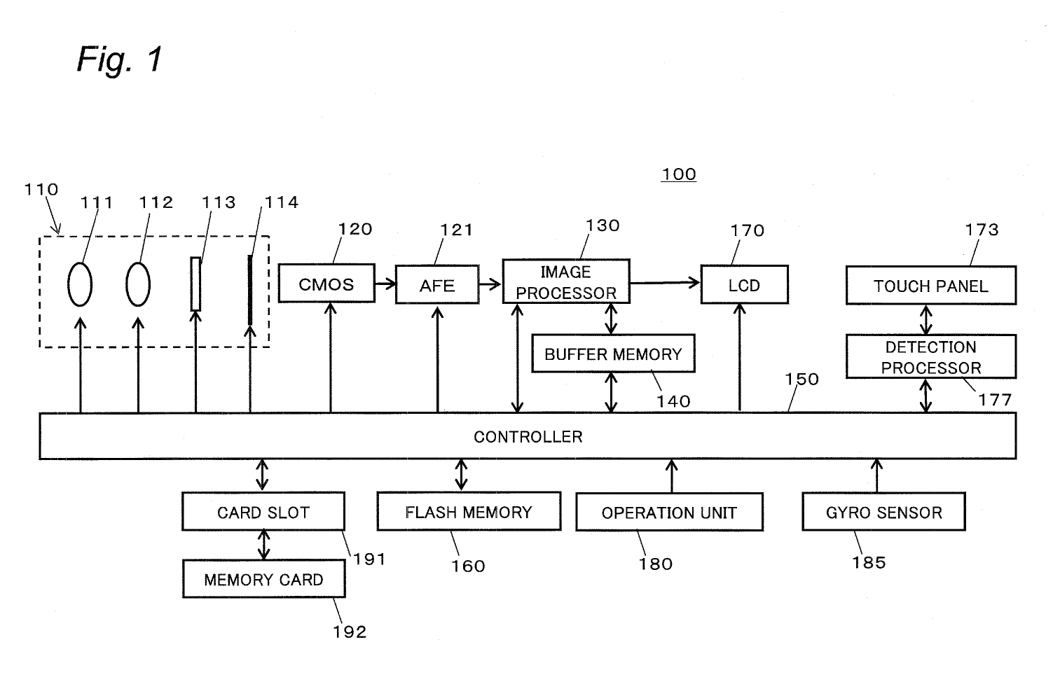

A configuration of the digital camera according to the embodiment will be described. FIG. 1 is a block diagram showing a configuration of the digital camera of the embodiment. The digital camera 100 captures a subject image formed via the optical system 110 with a CMOS image sensor 120. The CMOS image sensor 120 generates image data based on the captured subject image. The image data generated by the CMOS image sensor 120 is subject to various processes in an AFE (analog front end) 121 and an image processor 130. The image data subject to the various processes is recorded in a flash memory 160 and a memory card 192. The image data recorded in the flash memory 160 and the memory card 192 are displayed on the liquid crystal display 170 according to a user's operation on an operation unit 180. The image data captured by the CMOS image sensor 120 and processed by the image processor 130 is displayed as a through image on the liquid crystal display 170.

The optical system 110 includes a focus lens 111, a zoom lens 112, a diaphragm 113, and a shutter 114. The optical system 110 may include an optical shake correction lens (OIS: optical image stabilizer). The various lenses composing the optical system 110 may be composed of any number of lenses or any number of lens groups.

The focus lens 111 is used for adjusting a focal length. The zoom lens 112 is used for adjusting a magnitude of enlargement/reduction of a subject. The diaphragm is used for adjusting a mount of light incident to the CMOS image sensor 120. The shutter 114 adjusts exposure time of light incident to the CMOS image sensor 120. The focus lens 111, the zoom lens 112, the diaphragm 113, and the shutter 114 are driven by the corresponding driving units such as a DC motor or a stepping motor according to control signals sent from a controller 150.

The CMOS image sensor 120 captures a subject image formed via the optical system 110 to generate image data. The CMOS image sensor 120 generates image data of a new frame at a predetermined frame rate (for example, 30 frames/second). The controller 150 controls image data generation timing and an electronic shutter operation of the CMOS image sensor 120. The liquid crystal display 170 displays this image data one by one as a through image, and thus the user can check a condition of the subject at real time. Instead of the CMOS image sensor, other type of image sensor such as a CCD image sensor or NMOS image sensor may be used.

The AFE 121 performs processes such as correlated double sampling and gain adjustment on the image data generated by the CMOS image sensor 120. In the gain adjustment, a gain corresponding to ISO sensitivity is set. The image data is converted from analog format to digital format. Thereafter, the AFE 121 outputs the image data to the image processor 130.

The image processor 130 gives various processes to the image data. Examples of the various processes include gamma correction, a YC converting process, an electronic zoom process, a compressing process, and an decompression process, but not limited to them. The image processor 130 may be composed of a hard-wired electronic circuit or may be composed of a microcomputer executing a program. Further, the image processor 130 may be integrated in one integrated circuit with the controller 150.

The liquid crystal display 170 is provided on the rear surface of the digital camera 100. The liquid crystal display 170 displays an image based on the image data processed by the image processor 130. The image displayed by the liquid crystal display 170 includes a through image and a recorded image. The liquid crystal display 170 displays the image generated by CMOS image sensor every predetermined time as a through image at real time. By seeing the through image displayed on the liquid crystal display 170, the user can take an image while checking a composition of a subject. The recorded image is an image that is recorded in the memory card 192 or the flash memory 160. The liquid crystal display 170 displays an image based on the recorded image according to user's operation. The liquid crystal display 170 can further display settings of the digital camera 100, and so on.

The touch panel 173 is provided on a surface of the liquid crystal display 170 and outputs information about a position of an electrode on the touch panel 173 on which the user touches.

The detector 177 calculates the coordinate of the position of the touch panel on which the user touches based on the information about a position of an electrode from the touch panel 173, and outputs the calculated coordinate to the controller 150. With this information, the controller 150 can recognize the position on the touch panel 173 on which the user operates.

The controller 150 controls an entire operation of the digital camera 100. The controller 150 sends a control signal to the CMOS image sensor 120 and the image processor 130 based on a vertical synchronization signal (VD). The controller 150 is composed of a ROM for storing information such as a program, a CPU for processing the information, and so on. The ROM stores a program for controlling the entire operation of the digital camera 100 in addition to programs for autofocus control or autoexposure control.

The controller 150 controls the liquid crystal display 170 to display a menu so that a user can perform several settings while viewing the menu by operating the operation unit 180 or the touch panel 173. The controller 150 obtains the settings. Particularly, the controller 150 recognizes where in a frame displayed on the liquid crystal display 170 the user touches and performs a process according to the user's operation.

The controller 150 may be composed of a hard-wired electronic circuit or a microcomputer, and so on. The controller 150 as well as the image processor 130 may be composed of one semiconductor chip. The ROM may not be provided in the controller 150 and may be provided outside the controller 150.

A buffer memory 140 is a storage unit that functions as a work memory of the image processor 130 and the controller 150. The buffer memory 140 can be realized by DRAM (Dynamic Random Access Memory), and so on.

The flash memory 160 functions as an internal memory for storing image data, and so on. The controller 150 stores image data to be processed by the image processor 130 in the flash memory 160 or the memory card 192.

A gyro sensor 161 detects shake of the optical system 110 in a yawing direction and in a pitching direction based on an angle change (angular velocity) of the digital camera 100 per unit time. The gyro sensor 161 outputs a signal (gyro signal) representing the detected angular velocity to the controller 150.

A card slot 191 is a connecting unit to/from which the memory card 192 is attachable/detachable. The card slot 191 can electrically or mechanically connect the memory card 192. Further, the card slot 191 may have a function for controlling the memory card 192.

The memory card 192 is an external memory containing a storage device such as a flash memory. The memory card 192 can store data such as image data to be processed by the image processor 130. In the present embodiment, the memory card 192 is exemplified as an external memory, but other storage device such as an optical disk and HDD may be used as an external memory.

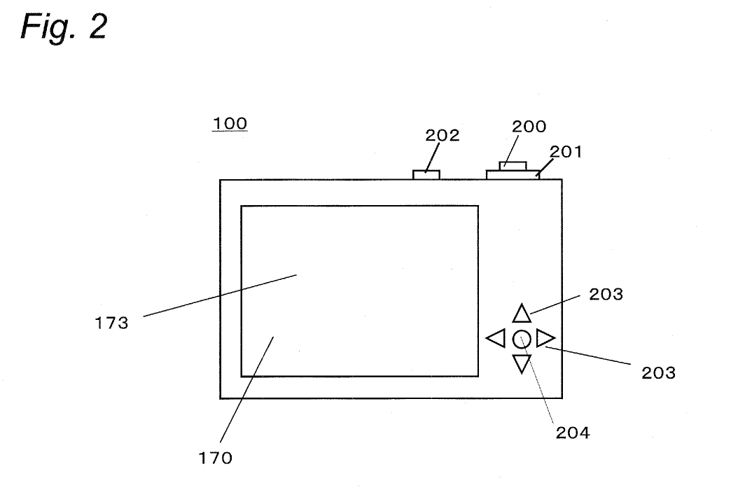

The operation unit 180 is a general name of operation buttons and operation levers provided to a casing of the digital camera 100, and receives user's operations. The operation unit 180 includes, as shown in FIG. 2, for example, a release button 201, a zoom lever 202, selection buttons 203, a set button 204, a power button 202 and the like. The operation unit 180 sends the controller 150 an operation instructing signal when receiving user's operation.

The release button 200 is a pressing-down button taking two states. When the release button 201 is half-pressed by the user, the controller 150 makes an autofocus control and an autoexposure control. When the release button 201 is full-pressed by the user, the controller 150 records image data generated at full-press timing as a recording image in the memory card 192 and so on.

The zoom lever 202 is a lever that naturally returns to a center position, having a wide-angle end position and a telephoto end position for angle adjustment. When operated by the user, the zoom lever 202 provides an operation instructing signal for driving the zoom lens 112 to the controller 150.

The power button 202 is a pressing-down type button for switching ON/OFF of supplying of a power to respective sections composing the digital camera 100. When the power button 203 is pressed down by the user with the digital camera 100 being off, the controller 150 supplies power to the respective sections of the digital camera 100 to activate them. Further, when the power button 203 is pressed down by the user with the digital camera 100 being on, the controller 150 stops the power supply to the respective sections.

The selection buttons 203 are pressing-down type buttons provided in up, down, right and left directions. When the user presses down any one of the selection buttons 203 showing any one of the directions, any one of various items displayed on the liquid crystal display 170 can be selected.

The set button 204 is a pressing-down type button. When the set button 204 is pressed down by the user with the digital camera 100 being in the recording mode or the reproducing mode, the controller 150 makes the liquid crystal display 170 display a menu screen. The menu screen is a screen for setting various conditions for recording/reproduction of image by the user. When the set button 204 is pressed down while one setting item is selected in the various condition setting items, the selected setting item is completely set.

### 1-2. Operation

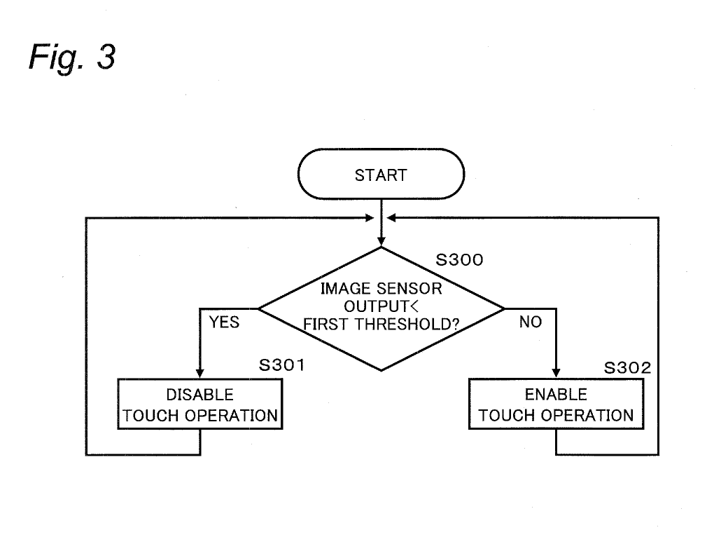

The operation of the digital camera 100 in the first embodiment will be described with reference to FIG. 3. The digital camera 100 in the first embodiment controls enabling/disabling of user's operation (namely, touch operation) through the touch panel 173 according to an output from the CMOS image sensor 120. That is to say, the digital camera 100 controls the enabling/disabling of a function for accepting the touch operation (hereinafter, “touch function”) according to the output from the CMOS image sensor 120.

FIG. 3 is a flowchart illustrating control of the touch panel through the controller 150 of the digital camera 100 in the first embodiment according to an output from the image sensor.

When the digital camera 100 is powered ON, the controller 150 supplies power to the respective sections to initially activate them. As a result, the optical system 110, the CMOS image sensor 120, and so on are in a state capable of shooting an image. In the state capable of shooting, the controller 150 controls the liquid crystal display 170 to display a generated image. As a result, the user can check the view angle of the currently captured image, on the liquid crystal display 170.

The image processor 130 detects a level (luminance) of light incident on the CMOS image sensor 120 via the optical system 110 based on the image data captured and generated by the CMOS image sensor 120. That is to say, the image processor 130 detects the level (luminance) of the light incident on the CMOS image sensor 120 based on the output from the CMOS image sensor 120, and sends the controller 150 a detected result.

The image processor 130 may detect the luminance using an average value of brightness on a region of the entire image output from the CMOS image sensor 120. In this case, by comparing the average value of brightness on the entire image with a predetermined threshold (a first threshold), the level (luminance) of the light incident on the CMOS image sensor 120 may be detected. In another manner, an average value of brightness on each of divided regions obtained by dividing the entire image region into a plurality of regions (for example, 8×8 pixels) may be used. When the average value of brightness on each divided region is used, the operation is performed as follows. That is to say, the image processor 130 obtains the average value of brightness on each divided region, and compares each of the obtained average value of brightness with the predetermined value. The image processor 130 compares a number of the divided regions where the average value of the brightness exceeds the predetermined value with the predetermined threshold (a first threshold) to detect the level (luminance) of the light incident on the CMOS image sensor 120. Using the divided regions to detect the luminance allows a point light source to be detected.

The controller 150 determines whether the output from the CMOS image sensor 120 is smaller than the first threshold (S300). When the output from the CMOS image sensor 120 is smaller than the first threshold (YES in step S300), the controller 150 disables the touch function (S301). As a result, the touch operation on the touch panel 173 by the user is disabled. That is to say, when the amount of light incident on the CMOS image sensor 120 is comparatively small, the controller 150 disables the touch function (touch operation). On the other hand, when the output from the CMOS image sensor 120 is larger than the first threshold (NO in step S300), the controller 150 enables the touch function (S302). As a result, the touch operation on the touch panel 173 by the user is enabled. That is to say, when the amount of light incident on the CMOS image sensor 120 is comparatively large, the controller 150 enables the touch function.

The controller 150 repeats the operation in steps S300 to S302 during the shooting operation. As a result, the digital camera 100 can control the enabling/disabling of the touch function (touch operation) according to the amount of light incident on the CMOS image sensor 120 during the shooting operation.

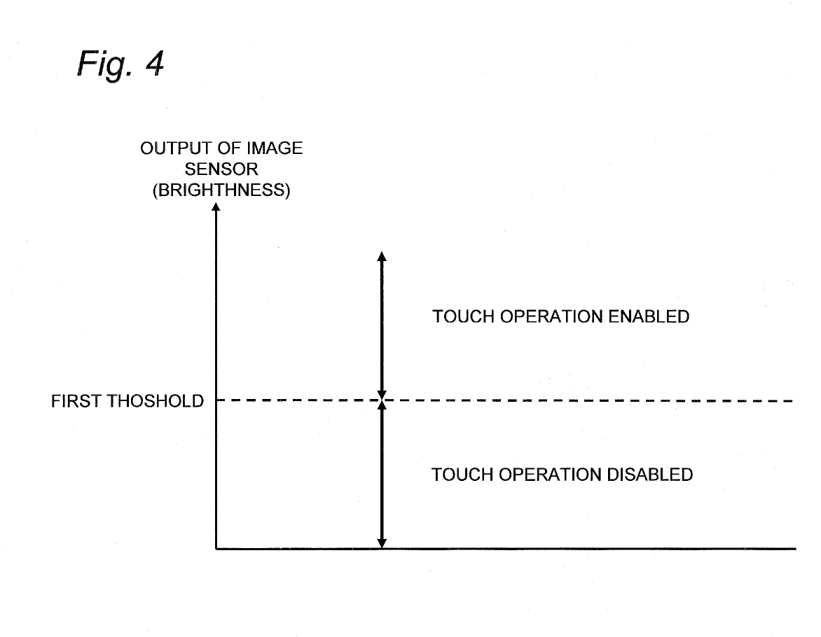

FIG. 4 is a diagram describing switching between the enabling/disabling of the touch function (touch operation) by means of the digital camera 100. A vertical axis represents the output level of the CMOS image sensor 120 (namely, the amount of incident light). As shown in FIG. 4, when the output from the CMOS image sensor 120 is smaller than the first threshold, the controller 150 disables the touch function, namely, the touch operation, and when the output from the CMOS image sensor 120 is larger than the first threshold, it enables the touch function, namely, touch operation.

The first threshold will be described below. It is normally considered that an extremely-dark environment (for example, a case where the camera is stored in a bag or a case) is not an environment where the user shots an image. Therefore, the first threshold is set to a value such that the extremely-dark environment is assumed. In general, as the darkest environment where the user shots an image, an environment at a time of night scene shooting is considered. Therefore, the first threshold can be set to a value smaller than a lower limit of the light amount in a condition that a night scene is shot, for example. By setting the first threshold to such a value, the controller 150 can automatically disable the touch function (touch operation) when the amount of light incident on the CMOS image sensor 120 is small. As a result, an operational error of the digital camera caused by unintended contact with the touch panel 173 can be reduced.

As to a case where the output from the CMOS image sensor 120 is smaller than the first threshold, some concrete examples will be described below.

### EXAMPLE 1

### Case Where Lens Cap is Attached

Particularly in a case of single-lens cameras, the digital camera to which a lens cap is attached and whose power is ON would be often stored in a bag and carried on. In that case, according to the control of the enabling/disabling of the touch function (touch operation) in the first embodiment, the attachment of the lens cap causes the output from the CMOS image sensor 120 to be the first threshold or less so that the touch function is automatically disabled. As a result, occurrence of an operational error, which is caused by contact of an inner wall of the bag and goods stored in the bag with the touch panel, can be reduced. At this time, the touch function is disabled, but the power is maintained at an ON state. As a result, when the user finds a subject that is desired to be shot while carrying the digital camera in the bag, the user can start to perform the shooting operation immediately because the power of the digital camera is ON. The user would occasionally move with the digital camera hanging from his/her neck with its power ON. Even in such a case, according to the control of the enabling/disabling of the touch function in the first embodiment, by attaching the lens cap to the digital camera to shield light, the occurrence of the incorrect touch operation caused by contact with a user's body can be reduced. Since the inside of the bag is always dark, by setting the first threshold to a value according to a use condition, the controller 150 can automatically disable the touch function when the digital camera in the power ON state is stored in the bag, even though the lens cap is not attached to the digital camera.

### EXAMPLE 2

### Case of Carrying-ON in Darkness

In a case where a night scene or a starlit sky is shot, the digital camera would be mostly carried on to a spot where an image is to be shot with its power being ON. At this time, even in a digital camera without a lens cap such as a compact digital camera, by setting the first threshold to a value smaller than a general lowest illuminance in shooting of the night scene or the starlit sky, the touch function can be disabled in a low-illuminance environment where the user does not intend to shoot an image.

Since the output from the CMOS image sensor is used for determining the enabling/disabling of the touch function, function for detecting whether the lens cap is attached to an interchangeable lens does not have to be additionally provided.

When the touch function is disabled, the AF operation or the other operation based on the touch operation is not performed. Therefore, when the touch function is disabled, power consumption can be repressed further than the case where the touch function is always enabled.

In a case where the digital camera is set to a scene mode of shooting with low illuminance, even when the output from the CMOS image sensor 120 becomes smaller than the first threshold, the touch function (touch operation) may not have to be disabled. The mode of shooting with low illuminance includes, for example, a night scene shooting mode, a starlit sky shooting mode, and a high-sensitive shooting mode.

The digital camera 100 in the first embodiment switches between enabling of the touch function and disabling the touch function according to the amount of incident light. As a result, an operational error on the touch panel caused by unintended contact can be reduced.

### Second Embodiment

The digital camera 100 in a second embodiment includes the CMOS image sensor for capturing a subject image to output image data, the liquid crystal display for displaying an image based on the output image data, the touch panel arranged on the liquid crystal display, for receiving a touch operation from the user, the gyro sensor for detecting a camera shake of the digital camera, and the controller for controlling enabling/disabling of the touch panel based on a detected result of the gyro sensor. With this constitution, the touch function (touch operation) is controlled to be enabled or disabled based on the detected result of the gyro sensor. As a result, occurrence of the operational error on the touch panel not intended by the user can be reduced.

The configuration and the operation of the digital camera 100 will be described below.

### 2-1. Configuration

Since the configuration of the digital camera in the second embodiment is similar to that in the first embodiment, the description thereof is not given.

### 2-2. Operation

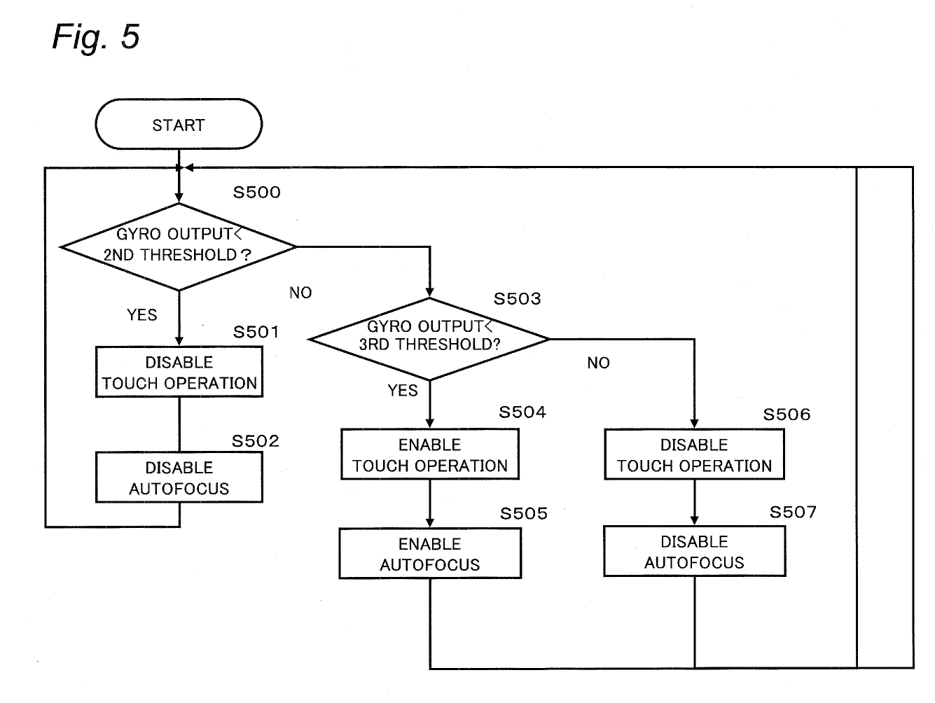

The digital camera 100 in the second embodiment controls enabling/disabling of the touch function, namely, the touch operation on the touch panel 173 according to the output of the gyro sensor 185. The operation of the digital camera in the second embodiment will be described below with reference to FIG. 5. FIG. 5 is a flowchart illustrating the operation of the digital camera in the second embodiment.

When the digital camera 100 is powered ON, the controller 150 supplies a power to the respective sections, so as to activate these sections. As a result, the optical system 110 and the CMOS image sensor 120 are in a state capable of shooting an image. In the state capable of shooting, the controller 150 controls the liquid crystal display 170 to display a generated image. As a result, the user can check the view angle of the currently captured image, on the liquid crystal display 170.

When the digital camera 100 is in the state capable of shooting, the controller 150 monitors an output from the gyro sensor 185. The controller 150 always calculates a result of a time average of the output from the gyro sensor 185.

Thereafter, the controller 150 determines whether the output from the gyro sensor 185 is smaller than a second threshold (S500). When the output from the gyro sensor 185 is smaller than the second threshold (YES in step S500), the touch function (namely, touch operation) is disabled (S501). The second threshold is set to a value corresponding to a situation where an amount of shake of the digital camera is extremely small, such as a situation where the digital camera is placed on a desk. When the second threshold is set in such a manner, the situation where the output from the gyro sensor 185 is smaller than the second threshold is assumed to be a case where the user has no intention of shooting an image. For this reason, when the user has no intention of shooting, the touch function (touch operation) does not have to be enabled, and the reduction in an operational error on the touch panel 173 has a priority. For this reason, the controller 150 disables the touch function. As a result, the power consumption can be reduced. The controller 150 disables the touch function together with the AF function (S502).

When the output from the gyro sensor 185 is larger than the second threshold (No in S500), the controller 150 determines whether the output from the gyro sensor 185 is smaller than a third threshold (S503). The third threshold is a value that corresponds to, for example, the case where the user is carrying the digital camera. The third threshold is set to a value corresponding to the case where it is assumed to have no user's intention of shooting but where the shake of the digital camera 100 occurs. With such setting of the threshold, when the output from the gyro sensor 185 is larger than the second threshold and is smaller than the third threshold, it can be assumed that the user holds the digital camera in his/her hands and tries to perform the shooting operation.

When the output from the gyro sensor 185 is smaller than the third threshold (YES in step S503), the controller 150 enables the touch function (touch operation) (S504). Further, the controller 150 enables the AF function (S505). At this time, when the AF mode is a continuous AF mode (a mode where the focus lens is continuously controlled so that a focus state is always obtained), with the AF function enabled, the AF operation is started. When the output from the gyro sensor 185 is larger than the second threshold and is smaller than the third threshold, it can be assumed that the user holds the digital camera on his/her hands and tries to perform the shooting operation. For this reason, the controller 150 starts the AF operation in advance before receiving the shooting start instruction from the user in order to complete the AF operation as soon as possible when receiving the shooting start instruction from the user.

Synchronization of the start timing of the AF operation and the enabling control of the touch function (touch operation) will be described below.

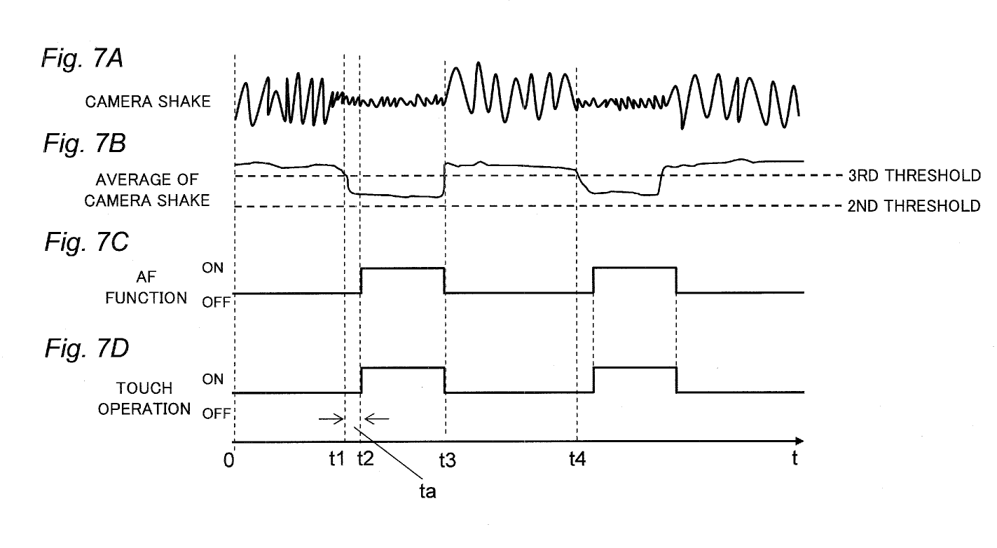

FIGS. 7A to 7D are diagrams describing the AF control and a control timing of the touch panel according to the output from the gyro sensor 185 in the second embodiment. In FIGS. 7A to 7D, it is assumed that the digital camera 100 is not placed on the desk, but is held by the user's hands. A horizontal axis in FIG. 7A to 7D represents time. FIG. 7A illustrates a shake amount of the digital camera 100 (the output from the gyro sensor 185). FIG. 7B illustrates an average value of the shake amount of the digital camera 100 (the output from the gyro sensor 185). FIG. 7C illustrates a control signal of the AF function (High level: ON and Low level: OFF). FIG. 7D illustrates a control signal of the touch function (High level: ON and Low level: OFF). While the time t is 0 to t1, a time average of the shake amount of the digital camera (for a time interval ta of averaging) is larger than the third threshold. For this reason, the controller 150 disables the AF function and the touch function. While the time t is t1 to t2, a situation where the time average of the shake amount of the digital camera is not more than the third threshold and not less than the second threshold continues for a constant time (ta) or more. Thereafter, the controller 150 enables the AF function and the touch function. While the time t is between t2 and t3, the time average of the shake amount of the digital camera 100 is not more than the third threshold and is not less than the second threshold. For this reason, the controller 150 enables both the AF function and the touch function. Hereinafter, the controller 150 repeats such a process.

As described above, the controller 150 enables the touch function (touch operation) in synchronization with timing at which the AF operation is started. The situation where the user desires the enabled touch function is assumed to be a situation that the user has intention of shooting an image. In the situation where the user has intention of shooting, it is desirable that the user starts the shooting operation as soon as possible according to the shooting timing desired by the user. To control simultaneously the control to start the AF operation in advance in order to perform the shooting operation as soon as possible, and the control to enable the touch function in the situation with user's intention of shooting has a high affinity. With these two controls that have high affinity for the simultaneous controls being synchronized with each other, the shooting operation can be started as soon as possible when the user has intention of shooting, and the touch function can be enabled according to this case. In other words, when the user has no intention of shooting, the AF operation does not have to be started in advance, and thus the touch function does not have to be enabled. For this reason, the digital camera 100 can enable the touch function in the situation where the user has intention of shooting so that the power consumption can be reduced in the situation where the user has no intention of shooting. Further, the simultaneous control can omit unnecessary parts and unnecessary steps of programs in comparison with a case of no simultaneous control from viewpoints of hardware design and software design.

The description returns to step S502 in FIG. 5. When the output from the gyro sensor 185 is larger than the third threshold (No in S502), the controller 150 disables the touch function (touch operation) (S505). When the output from the gyro sensor 185 is larger than the third threshold, it is assumed that the user has no intention of shooting such as the case where the user is carrying the digital camera. At this time, the touch function is not necessary, and the reduction in an operational error of the touch panel 173 takes priority. For this reason, the controller 150 disables the touch function.

The controller 150 repeats the operation in steps S500 to S505 in the state capable of shooting an image.

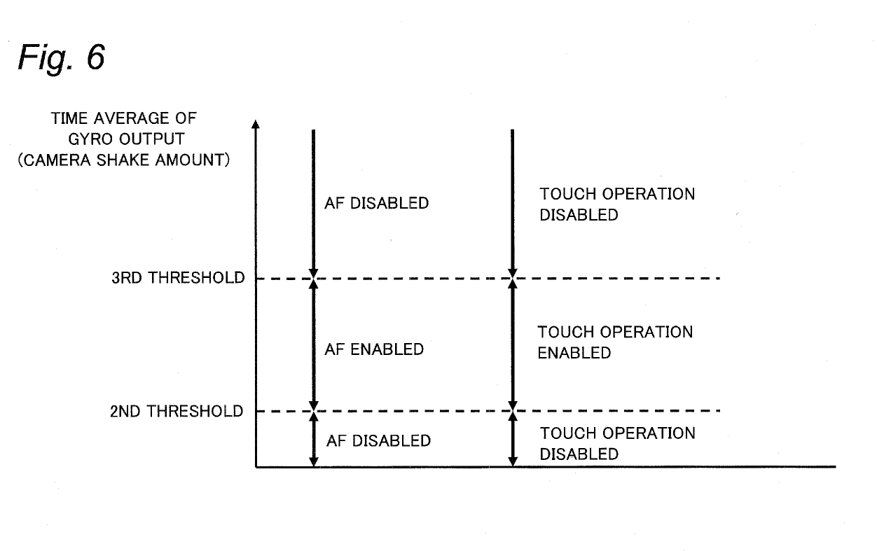

The switching operation between the enabling/disabling of the AF function and the touch function (touch operation) will be described with reference to FIG. 6. FIG. 6 is a diagram illustrating the control of the touch panel based on the output from the gyro sensor 185 according to the second embodiment. When the output from the gyro sensor 185 is smaller than the second threshold, the controller 150 disables the touch function. Similarly, when the output from the gyro sensor 185 is larger than the third threshold, the controller 150 disables the touch function. On the other hand, when the output from the gyro sensor 185 is between the second threshold and the third threshold, it is assumed that the user has intention of shooting. For this reason, the controller 150 enables the AF function to automatically start the AF operation, and simultaneously enables the touch function.

In the above description, the controller 150 switches the enabling/disabling of the touch function based on the output from the gyro sensor 185 in the state capable of shooting, but the embodiment is not limited to this. That is to say, the controller 150 may switch between the enabling and disabling of the touch function during an operation of reproducing a recording image, based on the output from the gyro sensor 185.

In the above description, the condition for enabling the touch function is set so that the output from the gyro sensor 185 is not less than the second threshold and is not more than the third threshold, but the embodiment is not limited to this. That is to say, the controller 150 may make a control to enable the touch function when the output from the gyro sensor 185 is not more than the second threshold. For example, when the digital camera 100 is fixed to a tripod or the like, it is assumed that the user has intention of shooting, and thus it may be preferable to enable the touch function even if the output is not more than the second threshold.

A menu may be provided which allows the user to set in advance ON/OFF control for automatically switching between enabling and disabling of the touch function. At this time, the touch function may be set by the user to be always enabled or disabled regardless of the output value from the gyro sensor 185.

When the touch function is enabled, an icon representing that the touch function is enabled may be displayed on the liquid crystal display 170. Similarly, when the touch function is disabled, an icon representing that the touch function is disabled may be displayed on the liquid crystal display 170. With such an icon, the user can easily check whether the touch function is currently enabled or disabled.

As stated above, the digital camera 100 of the second embodiment can switch between enabling and disabling of the touch function based on the output from the gyro sensor 185.

### Third Embodiment

The digital camera 100 of the third embodiment includes the CMOS image sensor 120 for capturing a subject image to output image data, the liquid crystal display 170 for displaying an image based on the output image data, the touch panel 173 arranged on the liquid crystal display 170 for receiving a touch operation from the user, the gyro sensor 185 for detecting shake of the digital camera 100, and the controller 150 for controlling the enabling/disabling of the operation of the touch panel 173 based on the output from the CMOS image sensor 120 and the detected result of the gyro sensor 185. The digital camera 100 can make a control to enable or disable the touch panel operation (the touch function) based on the output from the CMOS image sensor 120 and the detected result of the gyro sensor 185. As a result, the occurrence of an operational error of the touch panel which is not intended by the user can be reduced.

### 3-1. Configuration

A configuration of the digital camera 100 according to the third embodiment is similar to that in the above embodiments, and thus the description thereof is not given.

### 3-2. Operation

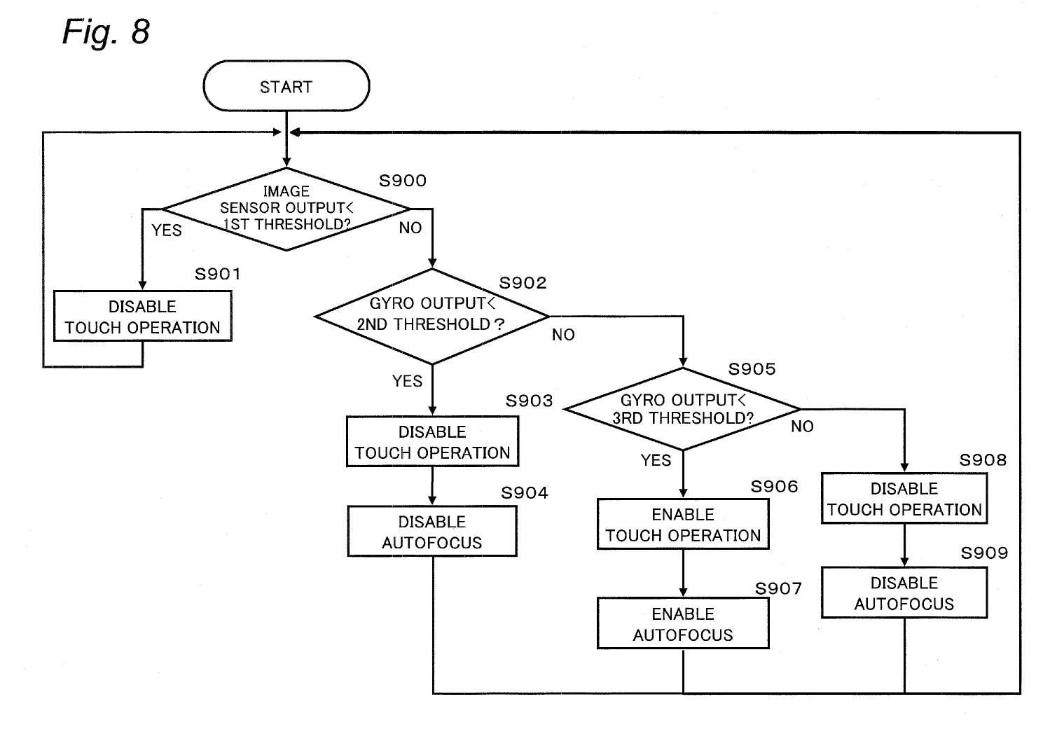

The operation of the digital camera according to the third embodiment will be described with reference to FIG. 8. The digital camera 100 according to the third embodiment controls the enabling/disabling of the touch function, i.e., the touch operation on the touch panel 173 according to the output from the CMOS image sensor 120 and the output from the gyro sensor 185.

FIG. 8 is a flowchart illustrating the operation of the digital camera according to the third embodiment. The first to third thresholds in the third embodiment are equal to the first to the third thresholds in the first and second embodiments.

When the digital camera 100 is powered ON, the controller 150 supplies a power to the respective sections so as to activate them. As a result, the optical system 110 and the CMOS image sensor 120 are in a state capable of shooting an image. In the state, the controller 150 controls the liquid crystal display 170 so that a generated image is displayed thereon. As a result, the user can check the view angle of the currently captured image, on the liquid crystal display 170.

At this time, the image processor 130 detects the level (luminance) of the light incident on the CMOS image sensor 120 via the optical system 110 based on the image data captured and generated by the CMOS image sensor 120. That is to say, the image processor 130 detects the level (luminance) of the light incident on the CMOS image sensor 120 based on the output from the CMOS image sensor 120. The image processor 130 notifies the controller 150 of the detected result.

The controller 150 determines whether the output from the CMOS image sensor 120 is smaller than the first threshold (S900). When the output from the CMOS image sensor 120 is smaller than the first threshold (YES in S900), the controller 150 disables the touch function, i.e., an input of the touch operation on the touch panel 173 (S901). That is to say, when the amount of the light incident on the CMOS image sensor 120 is relatively small, the controller 150 disables the touch function (touch operation). On the other hand, when the output from the CMOS image sensor 120 is larger than the first threshold (NO in S900), the controller 150 goes to step S902.

The operation in step S902 to S907 is similar to that in steps S500 to S505 in FIG. 5. That is to say, the output from the gyro sensor 185 is compared with the second threshold or the third threshold, and the enabling/disabling of the touch function and the AF function is set based on the comparison result.

According to the third embodiment, in the case where the digital camera 100 is stored in a bag with its power being ON without the lens cap, even when the output from the gyro sensor 185 is not large, the controller 150 can disable the touch function since the amount of light incident on the CMOS image sensor 120 is small. That is to say, when the amount of incident light is small, it is assumed that the user has no intention of shooting even though the digital camera 100 does not shake. For this reason, the controller 150 can disable the touch function.

According to the third embodiment, even in a case where the digital camera 100 is held while being exposed to outside the bag and is in a bright environment, the controller 150 can disable the touch function when the output value of the gyro sensor 185 is not more than the second threshold or not less than the third threshold, since it can be considered that the user has no intention of shooting.

In the digital camera 100 according to the third embodiment, the enabling/disabling of the touch function can be achieved with more of a reflection of the user's intention of shooting, compared to the case where the touch function is controlled based on only the output from the CMOS image sensor 120 (the first embodiment), or the case where the touch function is controlled based on only the output from the gyro sensor 185 (the second embodiment).

According to the aforementioned embodiments, the digital camera can be provided which can reduce occurrence of operational error of the touch panel not intended by the user.

### INDUSTRIAL APPLICABILITY

The aforementioned embodiments can be applied not only to a digital camera but also to an imaging apparatus such as a movie camera, information terminal with a camera and a game machine with a camera.

What is claimed is:

1. An imaging apparatus comprising:
an imaging sensor configured to capture a subject image to output image data;
a display unit configured to display an image based on the output image data;
a touch panel configured to receive an operation by user's touching, the touch panel arranged on the display unit; and
a controller configured to control enabling/disabling of the touch operation on the touch panel based on an output from the imaging sensor.

2. The imaging apparatus according to claim 1, wherein when a value represented by the output from the imaging sensor is smaller than a first threshold, the controller disables the operation on the touch panel.

3. The imaging apparatus according to claim 1, wherein when a value represented by the output from the imaging sensor is larger than a first threshold, the controller enables the operation on the touch panel.

4. An imaging apparatus comprising:
an imaging sensor configured to capture a subject image to output image data;
a display unit configured to display an image based on the output image data;
a touch panel configured to receive an operation by user's touching, the touch panel arranged on the display unit;
a detector configured to detect shake of the imaging apparatus; and
a controller configured to control enabling/disabling of the operation on the touch panel based on a detected result of the detector.

5. The imaging apparatus according to claim 4, wherein when a value represented by the detected result of the detector is smaller than a second threshold, the controller disables the operation on the touch panel.

6. The imaging apparatus according to claim 5, wherein when a value represented by the detected result of the detector is larger than the second threshold and smaller than a third threshold larger than the second threshold, the controller enables the operation on the touch panel.

7. The imaging apparatus according to claim 6, wherein when a value represented by the detected result of the detector is larger than the third threshold larger than the second threshold, the controller disables the operation on the touch panel.

8. The imaging apparatus according to claim 5, further comprising:
a focus lens configured to adjust a focus state of a subject image captured by the imaging sensor,
wherein when the detected result of the detector is larger than the second threshold, the controller makes autofocus control of the focus lens and makes a control to enable the operation on the touch panel.

9. An imaging apparatus comprising:
an imaging sensor configured to capture a subject image to output image data;
a display unit configured to display an image based on the output image data;
a touch panel configured to receive an operation by user's touching, the touch panel arranged on the display unit;
a detector configured to detect shake of the imaging apparatus; and
a controller configured to control enabling/disabling of the operation on the touch panel based on an output from the imaging sensor and a detected result of the detector.
